(19) United States
(12) Patent Application Publication
(10) Pub. No.: US 2026/0111036 A1
(43) Pub. Date: Apr. 23, 2026

(54) SMART TRANSPORT VEHICLE SPEED CONTROL DEVICE AND METHOD

(71) Applicants: Hyundai Motor Company, Seoul (KR); Kia Corporation, Seoul (KR)

(72) Inventors: Kyung Dong Park, Hwaseong (KR); Man Ki Lee, Hwaseong (KR)

(21) Appl. No.: 19/193,488

(22) Filed: Apr. 29, 2025

(30) Foreign Application Priority Data
Oct. 22, 2024 (KR) 10-2024-0144813

(51) Int. Cl. G05D 1/65; G05D 1/693; G05D 1/695; G05D 1/698; G05D 105/28; G05D 107/70

(52) U.S. Cl. CPC G05D 1/65; G05D 1/695; G05D 1/6987; G05D 1/693; G05D 2105/28; G05D 2107/70

(57) ABSTRACT

A speed control device includes: a control server including a processor and a memory, the processor configured to execute instructions to: receive information about a current location and a vehicle speed of a smart transport vehicle; receive process status information including a process speed for each line zone from a process line in which the smart transport vehicle operates; and when the current location is a first line zone designated in advance among all process line zones of the process line, adjust the vehicle speed based on a first process speed for the first line zone.

### CROSS-REFERENCE TO RELATED APPLICATION

This application claims under 35 U.S.C. § 119(a) the benefit of Korean Patent Application No. 10-2024-0144813 filed in the Korean Intellectual Property Office on Oct. 22, 2024, the entire contents of which are incorporated herein by reference.

### BACKGROUND

### (a) Technical Field

The present disclosure relates to a smart transport vehicle speed control device and method, more particularly, to a process line speed-based smart transport vehicle speed control device and method for causing unmanned smart logistics transport robots to travel in a cluster at a certain speed synchronized with a process line speed in a specific section.

### (b) Description of the Related Art

With the advancement of electronic technology, different types of robots are being developed. Robots are being used in various industrial, medical, and aerospace fields.

In particular, recently, automated guided vehicles (AGVs) that sort goods and transport the goods to their destinations on behalf of humans and robot vacuum cleaners that drive in indoor spaces of houses for cleaning have been developed.

Meanwhile, it is common for such robots to do work while moving at a constant speed. However, doing work at a preset speed in a space where the robots are allowed to move quickly may reduce the efficiency of the work. In addition, doing work at a speed set to be faster than a speed required for a space where the robot needs to move slowly poses a risk of collision or the like.

### SUMMARY

The present disclosure provides a smart transport vehicle speed control device and method capable of controlling speeds of automated guided vehicles (AGVs) to an average speed and to a constant speed when the AGVs enters the same zone, and controlling a driving speed of a robot to be synchronized with an actual line speed.

Particularly, the present disclosure provides a smart transport vehicle speed control device and method capable of operating a user-designated area as a prerequisite to match a flow of a logistics transport robot with a process line in a user-specified area.

The smart transport vehicle speed control device and method are configured to perform speed control and/or operate the user-designated area in a process line control environment.

An exemplary embodiment of the present disclosure provides a smart transport vehicle speed control device including: a control server comprising a processor and a memory, the processor configured to execute instructions to: receive, in a vehicle information reception unit of the control server, information about a current location and a vehicle speed of a smart transport vehicle; receive, in a line information reception unit of the control server, process status information including a process speed for each line zone from a process line in which the smart transport vehicle operates; and when the current location is a first line zone designated in advance among all process line zones of the process line, adjust, by a vehicle speed adjustment unit of the control server, the vehicle speed based on a first process speed for the first line zone.

According to another aspect, a process line speed-based smart transport vehicle speed control device includes: a vehicle information reception unit configured to receive information about a current location and a vehicle speed from a smart transport vehicle; a line information reception unit configured to receive process status information including a process speed for each line zone from a process line; and a vehicle speed adjustment unit configured to, when the current location is a first line zone designated in advance among all process line zones, adjust the vehicle speed based on a first process speed for the first line zone.

The vehicle information reception unit may receive whether the current location corresponds to one of a plurality of first line zones designated in advance.

The vehicle information reception unit may receive information about an average vehicle speed of a plurality of smart transport vehicles for each line zone.

The vehicle speed adjustment unit may synchronize the vehicle speed with the first process speed, and control the vehicle speed in real time in response to a change in first process speed so that the vehicle speed is kept equal to the first process speed.

The vehicle speed adjustment unit may adjust the vehicle speed to a preset designated speed when the current location is outside the first line zone.

The vehicle speed adjustment unit may set a first average vehicle speed of a plurality of first smart transport vehicles located in the first line zone to be equal to the first process speed, and adjust a vehicle speed of each of the first smart transport vehicles to be equal to the first average vehicle speed.

The vehicle speed adjustment unit may maintain a certain distance between adjacent vehicles among the plurality of first smart transport vehicles.

The certain distance may be greater than a minimum distance between sensors of the smart transport vehicles, and

The vehicle speed adjustment unit may adjust the vehicle speed based on the sensors when the adjacent first smart transport vehicles are close to each other by less than the minimum distance between the sensors, and adjust the vehicle speed based on the first average vehicle speed when the adjacent first smart transport vehicles are far away from each other by more than the certain distance.

A second smart transport vehicle driving in a second line zone, excluding the first line zone, among all the process line zones, may be individually controlled, and the vehicle speed adjustment unit may integrally control first smart transport vehicles driving in the first line zone.

The vehicle speed adjustment unit may request first smart transport vehicles in the first line zone to stop in a lump when the process line including the first line zone is stopped urgently.

Another exemplary embodiment of the present disclosure provides a smart transport vehicle speed control method including: receiving, by a control server comprising a processor and a memory, information about a current location and a vehicle speed of a smart transport vehicle; receiving, by the control server, process status information including a process speed for each line zone from a process line in which the smart transport vehicle operates; and when the current location is a first line zone designated in advance among all process line zones of the process line, adjusting, by the control server, the vehicle speed based on a first process speed for the first line zone.

According to a further aspect, a process line speed-based smart transport vehicle speed control method includes: receiving information about a current location and a vehicle speed from a smart transport vehicle; receiving process status information including a process speed for each line zone from a process line; and when the current location is a first line zone designated in advance among all process line zones, adjusting the vehicle speed based on a first process speed for the first line zone.

The receiving of the information about the current location and the vehicle speed from the smart transport vehicle includes receiving whether the current location corresponds to one of a plurality of first line zones designated in advance.

The receiving of the information about the current location and the vehicle speed from the smart transport vehicle may include receiving information about an average vehicle speed of a plurality of smart transport vehicles for each line zone.

The adjusting of the vehicle speed based on the first process speed for the first line zone may include synchronizing the vehicle speed with the first process speed, and controlling the vehicle speed in real time in response to a change in first process speed so that the vehicle speed is kept equal to the first process speed.

The adjusting of the vehicle speed based on the first process speed for the first line zone may include adjusting the vehicle speed to a preset designated speed when the current location is outside the first line zone.

The adjusting of the vehicle speed based on the first process speed for the first line zone may include setting a first average vehicle speed of a plurality of first smart transport vehicles located in the first line zone to be equal to the first process speed, and adjusting a vehicle speed of each of the first smart transport vehicles to be equal to the first average vehicle speed.

The adjusting of the vehicle speed based on the first process speed for the first line zone may further include maintaining a certain distance between adjacent vehicles among the plurality of first smart transport vehicles.

The certain distance may be greater than a minimum distance between sensors of the smart transport vehicles, and the adjusting of the vehicle speed based on the first process speed for the first line zone may further include adjusting the vehicle speed based on the sensors when the adjacent first smart transport vehicles are close to each other by less than the minimum distance between the sensors, and adjusting the vehicle speed based on the first average vehicle speed when the adjacent first smart transport vehicles are far away from each other by more than the certain distance.

The process line speed-based smart transport vehicle speed control method may further include: individually controlling a second smart transport vehicle driving in a second line zone, excluding the first line zone, among all the process line zones; and when the second smart transport vehicle enters the first line zone, integrally controlling the second smart transport vehicle as the first smart transport vehicle with other first smart transport vehicles driving in the first line zone.

The adjusting of the vehicle speed based on the first process speed for the first line zone may further include, when the process line including the first line zone is stopped urgently, requesting first smart transport vehicles in the first line zone to stop in a lump.

The process line speed-based smart transport vehicle speed control device and method according to an exemplary embodiment of the present disclosure can secure workability and stability and adjust a unit per hour (UPH) of vehicle production by controlling speeds of industrial transport vehicles (e.g., AGVs, AMRs, logistics robots) to an equal speed based on a process line speed with a specific designated area as a reference.

### BRIEF DESCRIPTION OF THE DRAWINGS

FIG. 1 schematically shows a process line speed-based smart transport vehicle speed control system according to an exemplary embodiment of the present disclosure.

FIG. 2 is a block diagram of a process line speed-based smart transport vehicle speed control device according to an exemplary embodiment of the present disclosure.

FIG. 3 is a flowchart of a process line speed-based smart transport vehicle speed control method according to an exemplary embodiment of the present disclosure.

FIG. 4 is a signal flow diagram for the process line speed-based smart transport vehicle speed control system according to an exemplary embodiment of the present disclosure.

FIG. 5 is a signal flow diagram for the process line speed-based smart transport vehicle speed control method according to an exemplary embodiment of the present disclosure.

FIG. 6 is an exemplary diagram for explaining the process line speed-based smart transport vehicle speed control method according to an exemplary embodiment of the present disclosure.

FIG. 7 is a diagram for explaining a computing device according to an exemplary embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings, so that they can be easily carried out by those having ordinary knowledge in the art to which the present disclosure pertains. However, the present disclosure may be implemented in various different forms, and is not limited to the exemplary embodiments described herein. In order to clearly explain the present disclosure, parts irrelevant to the description will be omitted from the drawings, and like parts will be denoted by like reference numerals throughout the specification.

Terms including ordinal numbers such as “first” and “second” may be used to describe various components, but these components are not limited by such terms. Such terms are used only for the purpose of distinguishing one component from another component.

Hereinafter, exemplary embodiments of the present disclosure will be described with reference to the drawings.

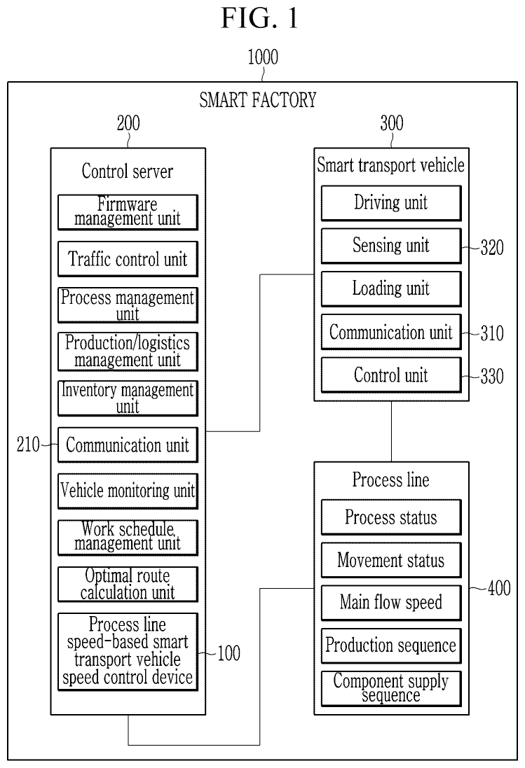

FIG. 1 schematically shows a process line speed-based smart transport vehicle speed control system according to an exemplary embodiment of the present disclosure.

The process line speed-based smart transport vehicle speed control system can be operated in a smart factory 1000.

The smart factory 1000 is an intelligent production plant that applies information and communication technology (ICT) combined with digital automation solutions to production processes such as design and development, manufacturing, and distribution to improve productivity, quality, and customer satisfaction.

The smart factory 1000 may install the Internet of Things (IoT) on facilities and machines inside the factory to collect process data in real time, analyze the process data, and control itself.

Referring to FIG. 1, the smart factory 1000 may include a control server 200 including a process line speed-based smart transport vehicle speed control device 100, a smart transport vehicle 300, and a process line 400.

The control server 200, the smart transport vehicle 300, and the process line 400 may be connected to each other through a network.

The process line speed-based smart transport vehicle speed control device 100 may adjust or control a vehicle speed of the smart transport vehicle 300 based on a process speed of the process line.

The process line speed-based smart transport vehicle speed control device 100 may be referred to as the smart transport vehicle speed control device 100 herein.

The smart transport vehicle speed control device 100 may adjust a vehicle speed or an operating flow of the smart transport vehicle 300 in accordance with the flow of the process line 400 when the smart transport vehicle 300 is used in the process line 400.

The smart transport vehicle speed control device 100 may be included in the control server 200, and managed and operated in the control server 200, but is not necessarily limited thereto. The smart transport vehicle speed control device 100 may be installed separately from the control server 200 and connected to the control server 200 via a network.

The control server 200 is a server that serves to monitor and control manufacturing processes or industrial processes in real time.

The control server 200 may collect data from various sensors or various kinds of equipment, and analyze the collected data to determine the process status or perform automated control.

The control server 200 can perform functions such as real-time data collection, data analysis, automated control, and history management.

The control server 200 may provide a user interface that enables a user or an operator to check the process status in real time and take a necessary action.

The control server 200 plays an important role in increasing the efficiency of the production process and improving quality control and productivity.

In an exemplary embodiment, the control server 200 may include a firmware management unit, a traffic control unit, a process management unit, a production/logistics management unit, an inventory management unit, a communication unit 210, a vehicle monitoring unit, a work schedule management unit, an optimal route calculation unit, and a process line speed-based smart transport vehicle speed control device 100.

The communication unit 210 may communicate with the process line 400 and the smart transport vehicle 300.

As described above, the process line speed-based smart transport vehicle speed control device 100 may control a vehicle speed of the smart transport vehicle 300 so that the smart transport vehicle 300 operates in accordance with the process flow of the process line 400 to increase the efficiency of the production process and improve quality control and productivity.

The smart transport vehicle 300 may be a smart unmanned logistics transport vehicle. That is, the smart transport vehicle 300 may refer to a robot or a vehicle that automatically transports goods in various industrial environments such as logistics warehouses, factories, and hospitals.

The smart transport vehicle 300 may move according to a route plan or autonomously, and perform a function of moving goods to designated locations without human intervention.

For example, the smart transport vehicle 300 may include an automated guided vehicle (AGV) and/or an autonomous mobile robot (AMR).

The smart transport vehicle 300 may include a driving unit, a communication unit 310, a sensing unit 320, a loading unit, and a control unit 330.

The communication unit 310 communicates with the control server 200, the smart transport vehicle speed control device 100, and the process line 400 in the smart factory 1000.

The sensing unit 320 may detect another smart transport vehicle 300 or another structure while driving to prevent a collision.

The control unit 330 may perform a control related to the driving of the smart transport vehicle or the robot.

The process line 400 may refer to a flow of a series of work steps that are sequentially connected to one another during a product production process.

The process line 400 may include a process line control system, such as a process programmable logic controller (PLC) and/or a supervisory control and data acquisition (SCADA) system.

The process line 400 may include a production line and a monitoring line.

The process line 400 may be a concept including various kinds of process equipment including a work station, a conveyor belt, automation equipment, and a control system required for a main process.

The process line 400 may provide various types of information related to the process line, including process status, movement status, main flow speed, production sequence, and component supply sequence.

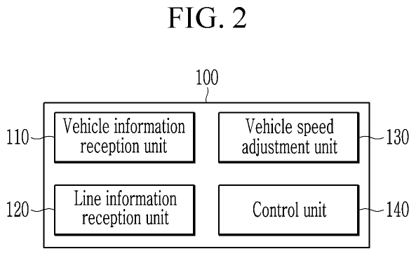

FIG. 2 is a block diagram of a process line speed-based smart transport vehicle speed control device according to an exemplary embodiment of the present disclosure.

Referring to FIG. 2, the smart transport vehicle speed control device 100 may include a vehicle information reception unit 110, a line information reception unit 120, a vehicle speed adjustment unit 130, and a control unit 140.

Each of the above units may constitute modules and/or devices of the smart transport vehicle speed control device 100, which may be a controller. For example, the above units of the smart transport vehicle speed control device 100 may constitute hardware components that form part of a controller (e.g., modules or devices of a high-level controller), or may constitute individual controllers each having a processor and memory. The smart transport vehicle speed control device 100 may include one or more processors and memory.

The vehicle information reception unit 110 may receive information about a current location and a vehicle speed of the smart transport vehicle from the smart transport vehicle.

The vehicle information reception unit 110 may receive whether the current location of the smart transport vehicle corresponds to one of a plurality of first line zones designated in advance.

Herein, the first line zones may be designated line zones requiring integrated control.

The plurality of first line zones may be designated in advance by the user or the operator as zones or areas where it is essential to integrally control (or control in a cluster) vehicle speeds of smart transport vehicles.

The entire process line may include a plurality of line zones. The line zones other than the first line zones may be referred to as second line zones.

In the second line zones, it may not be essential to integrally control vehicle speeds of smart transport vehicles.

In an exemplary embodiment, in order to integrally control vehicle speeds of smart transport vehicles, it is essential to designate first line zones in advance.

The vehicle information reception unit 110 may receive information about an average vehicle speed of a plurality of smart transport vehicles for each line zone.

The vehicle information reception unit 110 can receive an average value of vehicle speeds of first smart transport vehicles that are driving in the first line zone.

The vehicle information reception unit 110 may receive information about a vehicle speed and a current location from the smart transport vehicle 300 (see FIG. 1) or the control server 200 (see FIG. 1).

The line information reception unit 120 may receive process status information including a process speed for each line zone from the process line.

The process speed may include an operator's working speed, automatic control information from the process PLC, and a set target process speed. The process speed may be a numerical value calculated based on the worker's working speed, the automatic control information from the process PLC, and the set target process speed.

The line information reception unit 120 may receive a first process speed for the first line zone in real time from the process line 400 (see FIG. 1).

The vehicle speed adjustment unit 130 may adjust the vehicle speed of the smart transport vehicle based on the first process speed for the first line zone, when the current location of the smart transport vehicle is a first line zone designated in advance among all the process line zones.

The vehicle speed adjustment unit 130 may synchronize the vehicle speed of the first smart transport vehicle located in the first line zone with the first process speed.

That is, the vehicle speed adjustment unit 130 may adjust the vehicle speed in real time in response to a change in first process speed so that the vehicle speed of the first smart transport vehicle is kept equal to the first process speed.

The vehicle speed adjustment unit 130 may control the vehicle speed of the smart transport vehicle to a preset designated speed when the current location of the smart transport vehicle is outside the first line zone.

That is, the vehicle speed adjustment unit 130 may set a vehicle speed by individually controlling a smart transport vehicle that has left the first line zone.

The vehicle speed adjustment unit 130 may set a first average vehicle speed of a plurality of first smart transport vehicles located in the first line zone to be equal to the first process speed.

For example, if the first process speed is 0.8 ms and the current first average vehicle speed of the first smart transport vehicles is 0.74 ms, the vehicle speed adjustment unit 130 may adjust the first average vehicle speed to 0.8 m/s.

The vehicle speed adjustment unit 130 may adjust a vehicle speed of each of the first smart transport vehicles in the first line zone to be equal to the first average vehicle speed.

That is, the vehicle speed adjustment unit 130 may accelerate each of the first smart transport vehicles when the vehicle speed is smaller than 0.8 ms, and decelerate each of the first smart transport vehicles when the vehicle speed is greater than 0.8 ms.

The vehicle speed adjustment unit 130 may maintain a certain distance between adjacent vehicles among the plurality of first smart transport vehicles.

The vehicle speed adjustment unit 130 may adjust the vehicle speed of each of the adjacent first smart transport vehicles to maintain a preset certain distance and adjust the vehicle speed of each of the adjacent first smart transport vehicles to the first average vehicle speed.

Here, the certain distance may be greater than a minimum distance between sensors of the smart transport vehicles. For example, if the minimum distance between the sensors of the smart transport vehicles is 3 m, the certain distance may be 3.5 m.

The vehicle speed adjustment unit 130 may adjust the vehicle speed based on the sensors when the adjacent first smart transport vehicles are close to each other by less than the minimum distance between the sensors.

That is, the vehicle speed adjustment unit 130 adjusts the vehicle speed based on signals detected by the sensors.

The vehicle speed adjustment unit 130 may adjust the vehicle speed based on the first average vehicle speed when the adjacent first smart transport vehicles are far away from each other by more than the certain distance.

That is, the vehicle speed adjustment unit 130 may maintain the first average vehicle speed and simultaneously maintain the certain distance by decelerating a driving speed of a preceding vehicle or accelerating a driving speed of a following vehicle.

A second smart transport vehicle driving in the second line zone, excluding the first line zone, among all the process line zones, may be individually controlled.

In an exemplary embodiment, each of the second smart transport vehicles driving in the second line zone can be controlled via the control server 200.

Alternatively, the second smart transport vehicles may drive autonomously at individually-set vehicle speeds.

The vehicle speed adjustment unit 130 may integrally control first smart transport vehicles driving in the first line zone. That is, the vehicle speed adjustment unit 130 may simultaneously control the first smart transport vehicles by grouping them into one cluster.

The vehicle speed adjustment unit 130 may request first smart transport vehicles in the first line zone to stop in a lump when the process line including the first line zone is stopped urgently.

That is, the vehicle speed adjustment unit 130 may simultaneously stop all the first smart transport vehicles in the first line zone in an emergency situation.

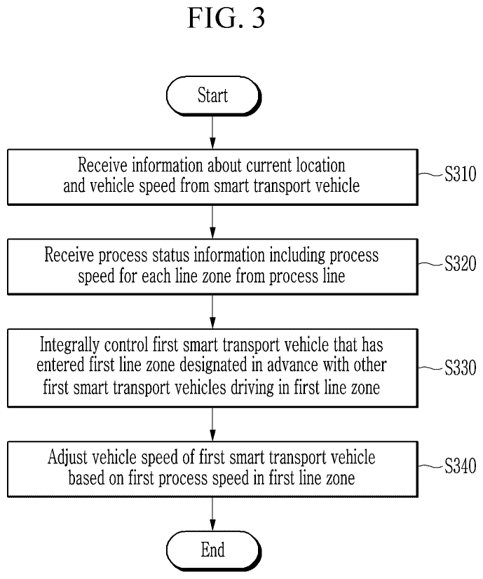

The control unit 140 may perform various controls such as data communication between the vehicle information reception unit 110, the line information reception unit 120, and the vehicle speed adjustment unit 130, signal processing, and interface provision. FIG. 3 is a flowchart of a process line speed-based smart transport vehicle speed control method according to an exemplary embodiment of the present disclosure. The process line speed-based smart transport vehicle speed control method of FIG. 3 may be performed by the process line speed-based smart transport vehicle speed control device 100 of FIGS. 1 and 2.

In FIG. 3, the smart transport vehicle speed control device 100 may receive information about a current location and a vehicle speed from a smart transport vehicle (step S310).

The smart transport vehicle speed control device 100 may receive whether the current location corresponds to one of a plurality of first line zones designated in advance. The smart transport vehicle speed control device 100 may receive information about an average vehicle speed of the plurality of smart transport vehicles for each line zone.

The smart transport vehicle speed control device 100 may receive process status information including a process speed for each line zone from the process line (step S320).

The smart transport vehicle speed control device 100 may integrally control a first smart transport vehicle that has entered a first line zone designated in advance with the other first smart transport vehicles driving in the first line zone (step S330).

A second smart transport vehicle driving in the second line zone, excluding the first line zone, among all the process line zones, may be individually controlled, but when the second smart transport vehicle enters the first line zone, the smart transport vehicle speed control device 100 may integrally control the second smart transport vehicle as a first smart transport vehicle with the other first smart transport vehicles.

The smart transport vehicle speed control device 100 may adjust a vehicle speed of the first smart transport vehicle based on the first process speed for the first line zone (step S340).

The smart transport vehicle speed control device 100 may synchronize the vehicle speed with the first process speed, and adjust the vehicle speed in real time in response to a change in first process speed so that the vehicle speed is kept equal to the first process speed.

The smart transport vehicle speed control device 100 may adjust the vehicle speed of the smart transport vehicle to a preset designated speed when the current location is outside the first line zone.

The smart transport vehicle speed control device 100 may set a first average vehicle speed of a plurality of first smart transport vehicles located in the first line zone to be equal to the first process speed, and adjust the vehicle speed of each of the first smart transport vehicles to be equal to the first average vehicle speed.

The smart transport vehicle speed control device 100 may maintain a certain distance between adjacent vehicles among the plurality of first smart transport vehicles.

The certain distance may be greater than a minimum distance between sensors of the smart transport vehicles.

The smart transport vehicle speed control device 100 may adjust the vehicle speed based on the sensors when the adjacent first smart transport vehicles are close to each other by less than the minimum distance between the sensors, and adjust the vehicle speed based on the first average vehicle speed when the adjacent first smart transport vehicles are far away from each other by more than the certain distance.

The smart transport vehicle speed control device 100 may request first smart transport vehicles in the first line zone to stop in a lump when the process line including the first line zone is stopped urgently.

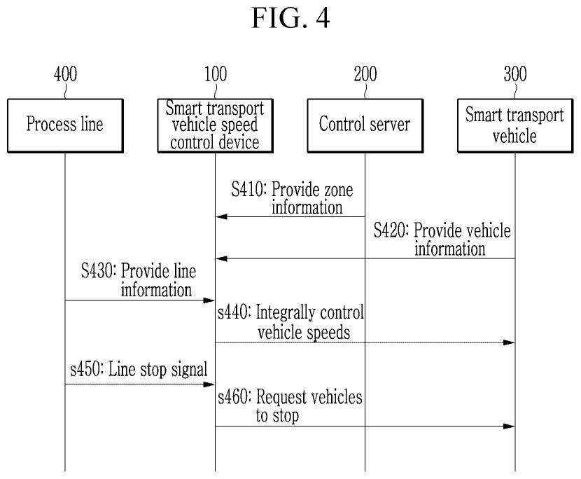

FIG. 4 is a signal flow diagram for the process line speed-based smart transport vehicle speed control system according to an exemplary embodiment of the present disclosure. In the exemplary embodiment of FIG. 4, the control server 200 and the smart transport vehicle speed control device 100 are separated from each other.

In FIG. 4, the control server 200 may provide line zone information about line zones including a first line zone designated as a zone where integrated control is essential in the entire process line to the smart transport vehicle speed control device 100 (step S410).

The smart transport vehicle 300 may provide vehicle information including a vehicle speed and a current location to the smart transport vehicle speed control device 100 (step S420).

The process line 400 may provide process line status information including a process speed related to the process line to the smart transport vehicle speed control device 100 (step S430).

The smart transport vehicle speed control device 100 may integrally control vehicle speeds of smart transport vehicles 300 within a designated zone based on the line zone information, the smart transport vehicle information, and the process line status information (step S440).

In an exemplary embodiment, the process line 400 may transmit a line stop signal to the smart transport vehicle speed control device 100 in an emergency situation where the process line is stopped (step S450).

Upon receiving the line stop signal, the smart transport vehicle speed control device 100 may provide a stop request to the smart transport vehicles (300) in the first line zone in an integrated manner.

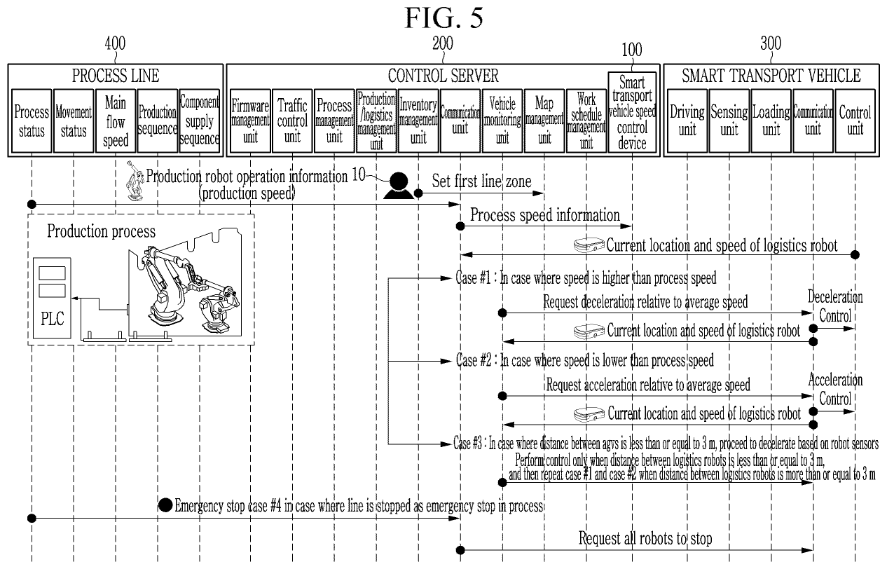

FIG. 5 is a signal flow diagram for a process line speed-based smart transport vehicle speed control method according to an exemplary embodiment of the present disclosure. In the exemplary embodiment of FIG. 5, the smart transport vehicle speed control device 100 is included in the control server 200.

In FIG. 5, an operator 10 may set a first line zone, which is a section where vehicle speeds are integrally controlled among line zones in the process line, through the control server 200.

The process line 400 may provide process status information including production robot operation information (production speed) to the control server 200.

The communication unit of the control server 200 may receive the process status information, and transmit the process status information to the smart transport vehicle speed control device 100.

The smart transport vehicle 300 may provide information about a current location and a vehicle speed of the smart transport vehicle 300 to the control server 200.

The smart transport vehicle 300 may provide information about a vehicle located in the first line zone and a vehicle speed of the vehicle.

At this time, in a case where the vehicle speed is higher than the process speed for the first line zone, the control server 200 may request a deceleration control to the smart transport vehicle 300.

That is, the control server 200 may request the smart transport vehicle 300 to decelerate to match the average vehicle speed synchronized with the process speed for the first line zone.

In a case where the vehicle speed is lower than the process speed for the first line zone, the control server 200 may request an acceleration control to the smart transport vehicle 300.

That is, the control server 200 may request the smart transport vehicle 300 to accelerate to match the average vehicle speed synchronized with the process speed for the first line zone.

After controlling the vehicle speed to be decelerated or accelerated according to the request of the control server 200, the smart transport vehicle 300 may provide a current location and a vehicle speed to the control server 200 in real time.

In an exemplary embodiment, the control server 200 may request the smart transport vehicle 300 to decelerate or accelerate the vehicle speed only when a distance between smart transport vehicles 300 in the first line zone is greater than a specific distance.

If the distance between smart transport vehicles 300 is smaller than the specific distance, the smart transport vehicles 300 may perform deceleration or acceleration controls based on individually equipped sensors.

Here, the specific distance may be a minimum distance within a sensor range, for example, 3 m.

The process line 400 may provide emergency stop status information as process status information to the control server 200 when the process line is stopped in an emergency situation.

Upon receiving the emergency stop status information, the control server 200 may request the smart transport vehicles 300 located in the first line zone to stop in an integrated manner. The smart transport vehicles 300 may be controlled to stop in a lump when the integrated stop request is received.

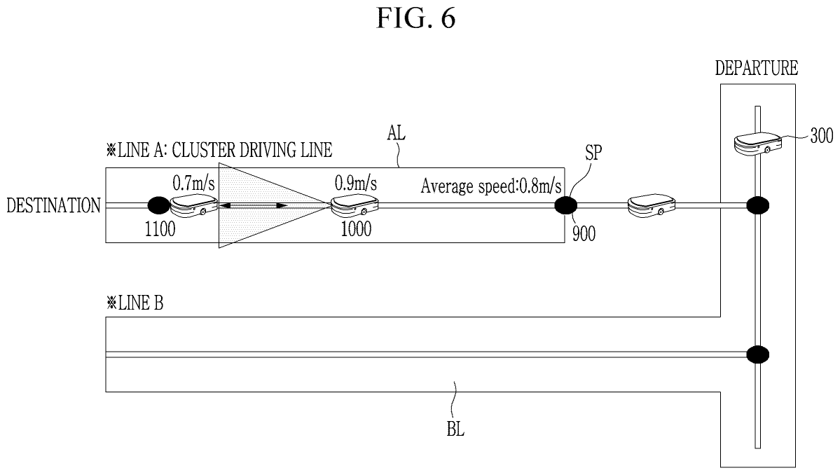

FIG. 6 is an exemplary diagram for explaining the process line speed-based smart transport vehicle speed control method according to an exemplary embodiment of the present disclosure.

In FIG. 6, the smart transport vehicle 300 moves along a route based on a line selected as the shortest distance when passing through a plurality of lines AL and BL in the process line.

The plurality of lines AL and BL in the process line may include line A (AL) in which smart transport vehicles 300 that are driving are integrally controlled to be driven in a cluster and line B (BL) in which a smart transport vehicle 300 is individually controlled.

The smart transport vehicle speed control device 100 may set a target speed of the smart transport vehicles 300 driving in line A (AL) based on the process speed and drive the smart transport vehicles 300 at a constant speed in accordance with the target speed.

In an exemplary embodiment, a smart transport vehicle 300 that has departed from the departure may stand by for a certain period of time before entering line A (AL). That is, the smart transport vehicle 300 may depart after standing by for the certain period of time at a cluster driving start point SP before entering line A (AL), taking into account a synchronization time for cluster driving.

In FIG. 6, the average speed of the smart transport vehicles 300 driving in line A (AL) is 0.8 m/s based on the process line speed.

In a situation where a front vehicle is driving at 0.7 m/s and a rear vehicle is driving at 0.9 m/s, a distance between the front vehicle and the rear vehicle is greater than 3 m, which is a minimum distance that is sensor-detectable.

Therefore, the smart transport vehicle speed control device 100 may decelerate the vehicle speed of the rear vehicle to match the average speed.

The smart transport vehicle speed control device 100 may accelerate the vehicle speed of the front vehicle driving at a speed lower than the average speed to match the average speed.

In a case where there are multiple lines in the process line, when the number of smart transport vehicles 300 in a specific line exceeds a limit, the control server 200 (see FIG. 1) may set a driving route for some of the smart transport vehicles 300 to drive in different lines.

That is, when an average speed of smart transport vehicles 300, including AGVs AMRs that have entered a first line zone designated by a user, is lower or higher than the target process speed, the smart transport vehicle speed control device 100 may control the speeds of the smart transport vehicles 300 that have entered the first line zone to match the target process speed.

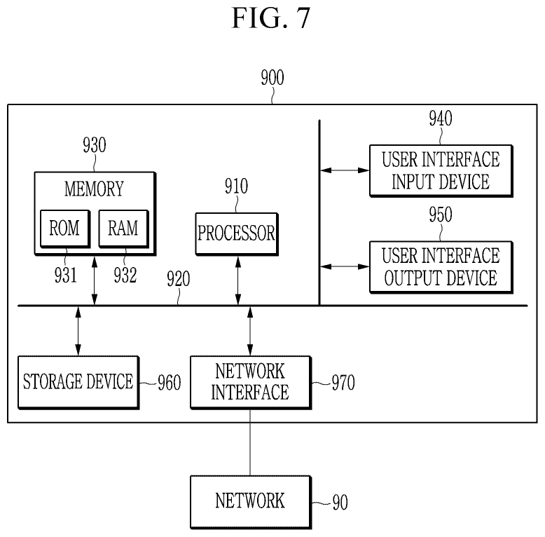

FIG. 7 is a diagram for explaining a computing device according to an exemplary embodiment of the present disclosure.

Referring to FIG. 7, the process line speed-based smart transport vehicle speed control device and method according to exemplary embodiments may be implemented using a computing device 900.

The computing device 900 may include at least one of a processor 910, a memory 930, a user interface input device 940, a user interface output device 950, and a storage device 560, which communicates with each other through a bus 920. The computing device 900 may also include a network interface 970 electrically connected to the network 90. The network interface 970 may transmit or receive signals to or from other entities via the network 90.

The processor 910 may be implemented in various types such as a micro controller unit (MCU), an application processor (AP), a central processing unit (CPU), a graphic processing unit (GPU), a natural processing unit (NPU), and the like, and may be any semiconductor device that executes instructions stored in the memory 930 or the storage device 960. The processor 910 may be configured to implement the above-described functions and methods described above with respect to FIGS. 1 to 6.

The memory 930 and the storage device 960 may include various types of volatile or non-volatile storage media. For example, the memory may include a read-only memory (ROM) 931 and a random access memory (RAM) 932. In the present exemplary embodiment, the memory 930 may be located inside or outside the processor 910, and the memory 930 may be connected to the processor 910 through various known means.

In some exemplary embodiments, at least some of the configurations or functions of the process line speed-based smart transport vehicle speed control device and method according to the exemplary embodiments may be implemented by programs or software executed by the computing device 900, and the programs or software may be stored in a computer-readable medium.

In some exemplary embodiments, at least some of the configurations or functions of the process line speed-based smart transport vehicle speed control device and method according to the exemplary embodiments may be implemented using hardware or circuitry of the computing device 900, or may be implemented by separate hardware or circuitry that may be electrically connected to the computing device 900.

Although the exemplary embodiments of the present disclosure have been described in detail above, the scope of the present disclosure is not limited thereto, and various modifications and improvements made by those having ordinary knowledge in the art to which the present disclosure pertains using the basic concept of the present disclosure defined in the following claims also fall within the scope of the present disclosure.

What is claimed is:

1. A smart transport vehicle speed control device comprising:
a control server comprising a processor and a memory, the processor configured to execute instructions to:
receive, in a vehicle information reception unit of the control server, information about a current location and a vehicle speed of a smart transport vehicle;
receive, in a line information reception unit of the control server, process status information including a process speed for each line zone from a process line in which the smart transport vehicle operates; and
when the current location is a first line zone designated in advance among all process line zones of the process line, adjust, by a vehicle speed adjustment unit of the control server, the vehicle speed based on a first process speed for the first line zone.

2. The speed control device of claim 1, wherein the vehicle information reception unit receives whether the current location corresponds to one of a plurality of first line zones designated in advance.

3. The speed control device of claim 1, wherein the vehicle information reception unit receives information about an average vehicle speed of a plurality of smart transport vehicles for each line zone.

4. The speed control device of claim 1, wherein the vehicle speed adjustment unit synchronizes the vehicle speed with the first process speed, and controls the vehicle speed in real time in response to a change in first process speed so that the vehicle speed is kept equal to the first process speed.

5. The speed control device of claim 1, wherein the vehicle speed adjustment unit adjusts the vehicle speed to a preset designated speed when the current location is outside the first line zone.

6. The speed control device of claim 1, wherein the vehicle speed adjustment unit sets a first average vehicle speed of a plurality of first smart transport vehicles located in the first line zone to be equal to the first process speed, and adjusts a vehicle speed of each of the first smart transport vehicles to be equal to the first average vehicle speed.

7. The speed control device of claim 6, wherein the vehicle speed adjustment unit maintains a certain distance between adjacent vehicles among the plurality of first smart transport vehicles.

8. The speed control device of claim 7, wherein:
the certain distance is greater than a minimum distance between sensors of the smart transport vehicles, and
the vehicle speed adjustment unit adjusts the vehicle speed based on the sensors when the adjacent first smart transport vehicles are close to each other by less than the minimum distance between the sensors, and adjusts the vehicle speed based on the first average vehicle speed when the adjacent first smart transport vehicles are far away from each other by more than the certain distance.

9. The speed control device of claim 1, wherein:
a second smart transport vehicle driving in a second line zone, excluding the first line zone, among all the process line zones, is individually controlled, and
the vehicle speed adjustment unit integrally controls first smart transport vehicles driving in the first line zone.

10. The speed control device of claim 1, wherein the vehicle speed adjustment unit requests first smart transport vehicles in the first line zone to stop in a lump when the process line including the first line zone is stopped urgently.

11. A smart transport vehicle speed control method comprising:
receiving, by a control server comprising a processor and a memory, information about a current location and a vehicle speed of a smart transport vehicle;
receiving, by the control server, process status information including a process speed for each line zone from a process line in which the smart transport vehicle operates; and
when the current location is a first line zone designated in advance among all process line zones of the process line, adjusting, by the control server, the vehicle speed based on a first process speed for the first line zone.

12. The speed control method of claim 11, wherein the receiving of the information about the current location and the vehicle speed from the smart transport vehicle includes:
receiving whether the current location corresponds to one of a plurality of first line zones designated in advance.

13. The speed control method of claim 11, wherein the receiving of the information about the current location and the vehicle speed from the smart transport vehicle includes:
receiving information about an average vehicle speed of a plurality of smart transport vehicles for each line zone.

14. The speed control method of claim 11, wherein the adjusting of the vehicle speed based on the first process speed for the first line zone includes:
synchronizing the vehicle speed with the first process speed, and controlling the vehicle speed in real time in response to a change in first process speed so that the vehicle speed is kept equal to the first process speed.

15. The speed control method of claim 11, wherein the adjusting of the vehicle speed based on the first process speed for the first line zone includes:
adjusting the vehicle speed to a preset designated speed when the current location is outside the first line zone.

16. The speed control method of claim 11, wherein the adjusting of the vehicle speed based on the first process speed for the first line zone includes:
setting a first average vehicle speed of a plurality of first smart transport vehicles located in the first line zone to be equal to the first process speed, and adjusting a vehicle speed of each of the first smart transport vehicles to be equal to the first average vehicle speed.

17. The speed control method of claim 16, wherein the adjusting of the vehicle speed based on the first process speed for the first line zone further includes:
maintaining a certain distance between adjacent vehicles among the plurality of first smart transport vehicles.

18. The speed control method of claim 17, wherein:
the certain distance is greater than a minimum distance between sensors of the smart transport vehicles, and
the adjusting of the vehicle speed based on the first process speed for the first line zone further includes adjusting the vehicle speed based on the sensors when the adjacent first smart transport vehicles are close to each other by less than the minimum distance between the sensors, and adjusting the vehicle speed based on the first average vehicle speed when the adjacent first smart transport vehicles are far away from each other by more than the certain distance.

19. The speed control method of claim 11, further comprising:
individually controlling a second smart transport vehicle driving in a second line zone, excluding the first line zone, among all the process line zones; and
when the second smart transport vehicle enters the first line zone, integrally controlling the second smart transport vehicle as the first smart transport vehicle with other first smart transport vehicles driving in the first line zone.

20. The speed control method of claim 11, wherein the adjusting of the vehicle speed based on the first process speed for the first line zone further includes:
when the process line including the first line zone is stopped urgently, requesting first smart transport vehicles in the first line zone to stop in a lump.
